(19) United States
(12) Patent Application Publication
(10) Pub. No.: US 2008/0162825 A1
(43) Pub. Date: Jul. 3, 2008

(54) METHOD FOR OPTIMIZING DISTRIBUTED MEMORY ACCESS USING A PROTECTED PAGE

(75) Inventors: Gheorghe C. Cascaval, Carmel, NY (US); Ying Chau Raymond Mak, Thornhill (CA)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/618,975

(22) Filed: Jan. 2, 2007

(51) Int. Cl. G06F 12/00

(52) U.S. Cl. 711/152; 711/E12.001

(57) ABSTRACT

A method for optimizing distributed memory access using a protected page. The method includes generating library calls to perform array accesses. The method further includes generating a layout map or assisting the accesses. Each processor possesses a local copy of this map. The method proceeds by allocating arrays across the processors, such that each processor receives a local portion of the array. The method further proceeds by reserving the memory location immediately before the local address. Then, the method proceeds by placing the memory location address under access protection, such that a protected page is formed.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to memory access, and more particularly to optimizing distributed memory access using a protected page.

2. Description of Background

Data parallelization abstraction can free programmers from the technical details of distributed memory accesses. The abstraction hides the underlying topology of physical memory so that program code can focus on the algorithm in the problem domain, rather than the hardware implementation. The distributed memory appears to be globally accessible from the high level programming language's perspective. But the expressiveness of the language in combination with programming convenience hides away important information about data locality. Without such information, the location characteristic or individual accesses cannot always be determined during compile time. The compiler now needs to generate code to handle the access regardless of where memory resides. This introduces a penalty for those accesses that turn out to be local, when the memory is directly connected to the same processor as the running code.

Broadly speaking, there are two ways to approach this: (1) Avoid it by reducing the expressiveness of data parallelization abstraction. That is, require the programmer to specify, either through syntactic constructs, or parameters in library function call, the where about of memory. The message passing interface (MPI) takes this approach using library calls. However, this takes away an important objective of providing data abstraction. The resulting program can be difficult to maintain. The problem is essentially swept away by removing a feature that set out to improve programmer productivity. (2) Use interprocedural analysis (IPA) aggressively to obtain information about data locality. IPA is expensive in terms of compile time. Furthermore, even if the required information on data locality can be obtained suing static analysis, it is not always possible to apply the information to all the array accesses involved. The compiler may need to choose to optimize on array at the expense of the others. In the end, the performance gain from the aggressive analysis may not justify the significant demand on compilation resources.

Thus, there is a need for a technique that limits the overhead of accessing distributed memory.

### SUMMARY OF THE INVENTION

The shortcomings of the prior art are overcome and additional advantages are provided through the provision of a method for optimizing distributed memory access using a protected page. The method includes generating library calls to perform array accesses. The method further includes generating a layout map for assisting the accesses. Each processor possesses a local copy of this map. The method proceeds by allocating arrays across the processors, such that each processor receives a local portion of the array. The method further proceeds by reserving the memory location immediately before the local address. Then, the method proceeds by placing the memory location address under access protection, such that a protected page is formed.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a method for optimizing distributed memory access using a protected page.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1a illustrates one example of an architecture model for supporting distributed memory;

FIG. 1b illustrates another example of an architecture model for supporting distributed memory;

FIG. 2 illustrates one example of elements of a matrix being dispersed across a plurality of processors; and

FIG. 3 illustrates one example of a method for optimizing distributed memory access using a protected page in accordance with the disclosed invention.

The detailed description explains an exemplary embodiment of the invention, together with advantages and features, by way of example with reference to the drawings.

### DETAILED DESCRIPTION OF THE INVENTION

The disclosed method does not conflict nor replace interprocedural analysis (IPA) previously presented. The method can work in conjunction with IPA, and provide reasonable optimization without requiring in depth static analysis.

The disclosed method uses a memory map to represent the distributed data layout (i.e. the way the array, the data, is distributed across the processors), and uses special trap addresses in the map to raise signals or interrupts when the access needs to go out of the current processor. When the access is within the same processor, the map provides a direct translation to the local address, minimizing the access overhead. The long code path is invoked only when the access needs to go to another process. The trap address mechanism, implemented by a protected page, will pass control to a handler, which handles the remote access.

One way to provide high-level data abstraction in a multi-processor architecture is to present them as arrays at the programming language level. There is no difference in the syntactic constructs used to access memory local to the processor (where the code i running), or remote in a different processor. On a physical level, the array elements are distributed across the processors. Accesses to local memory are fast while to remote ones are slow. To shield the program from the low level details of memory locality, the compiler generates instruction sequence to handle all memory accesses. But the convenience provided by the programming language also takes away information about data locality. It is not possible in all cases to determine the location characteristic of individual accesses during compile time. The instruction sequence generated needs to handle all possibilities, remote or otherwise. To better organize the generated code, a runtime library can be used to manage the distributed memory and their accesses. If an access is remote, the runtime would route it to the designated processor, and handle the necessary handshaking and synchronization. This provides a consistent and homogenous view of memory at the programming language level.

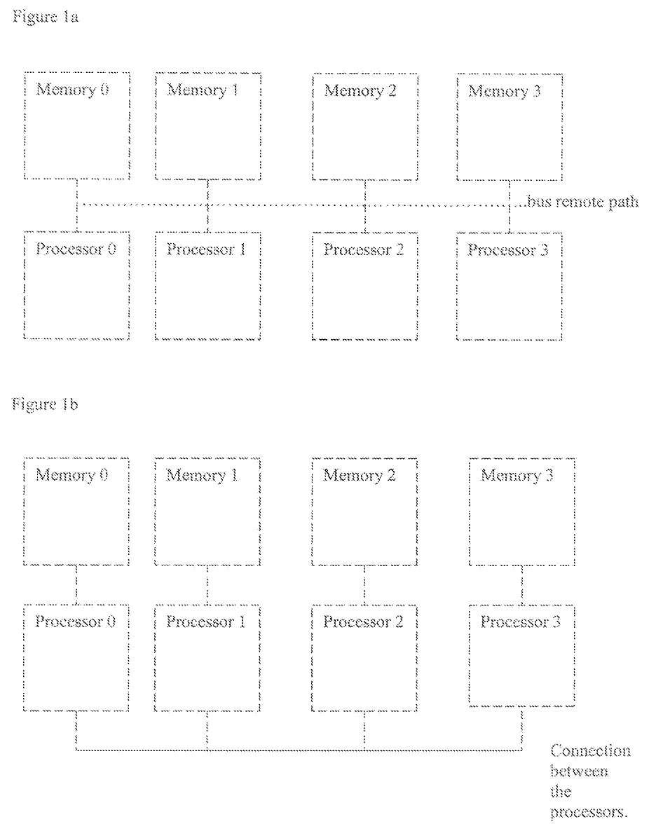

FIGS. 1a and 1b depict the general architecture models supporting distributed memory. In both cases, there is a series of processors (designated P0, P1, . . . ). There is also a corresponding series of memory blocks (designated Memory 0, Memory 1, . . . ). The aggregate of these memory blocks constitutes the distributed memory space. The line connecting processor Pi with memory Mi indicates that there is affinity between the memory block with its processor—i.e. the access of Mi by Pi is fast. This is called local access, in FIG. 1a there is also a bus connecting the memory blocks and the processors (the horizontal line). This bus provides a route for Pi to access Mj when i is not equal to j, this is called remote access. The access time for remote access could be slower than the local one. As a special case, they could be the same, representing an SMP architecture.

FIG. 1b provides remote access through connection between the processors; i.e., via a network. In this case, the access of Pi/Mj would go through the processor Pj, MPI is based on this model. There are also memory blocks private to each processor.

The disclosed protected page method applies to both FIGS. 1a and 1b. The only assumption here is that the access time for local and remote access could be different, and remote access is slower.

For example, assuming that the implementation uses a runtime library to manage all accesses to distributed memory. The compiler would generate library calls to do array accesses, there is an overhead to such calls. At a later stage during optimization, the optimizer can sometimes change the call into direct memory access based on memory locality. Essentially, it inlines the call and then further optimized if it can prove that the memory resides in the same processor as the running code. But since the compiler cannot determine in all cases if a particular access is local or remote, such optimization is not easy nor always possible. Loop transformation can be used so that loop iterations can stay within a memory range residing in the same processor before iterating into another one; and, through inlining, can eliminate some of the overheads in the function calls. Yet, different arrays may be distributed differently across the processors. A transformation that benefits one array may penalize another. The disclosed method addresses the situation where the optimizer cannot find a transformation, which benefits all the arrays used within a loop, and therefore needs to trade-off with one another. The method can be used to limit the performance penalty of those array accesses that cannot be optimized.

This situation can be illustrated by the following example. Suppose the following arrays exist with elements distributed on either (8) processors:

```
#pragma distribute_memory (matrix,...)
#pragma distribute_memory (vector,...)
int matrix [8] [8];
int vector [8];
int i;
int sum2=0;
  for (i=0; i<8; ++i) {
        sum2 += vector [i] * matrix [2] [i];
  }
```

Assume there is a pragma directive in the implementation that tells the compiler how the arrays are distributed. The “. . . ” in the program directive stands for additional information about the array layout. The exact details of this pragma directive are of no concern. Also, different programming languages and implementations may have different ways of specifying this information. The net effect is that the arrays are distributed across the processors.

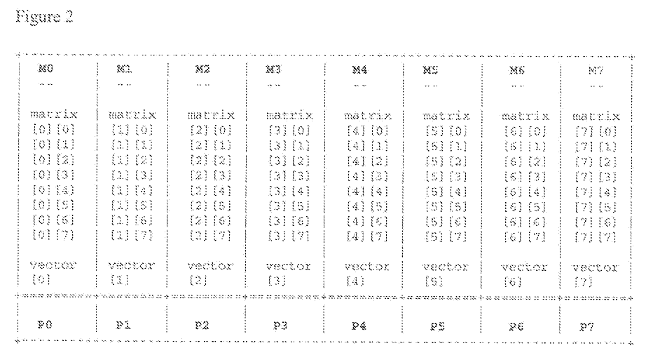

Referring to FIG. 2, suppose the elements of matrix are laid out across processors P0-P7 as shown. (Following FIGS. 1a and 1b, at the bottom are the processors, P0, P1, . . . Above = = =0 line are the distributed memory). It is possible to determine that all elements of the column matrix [2][.] reside in the same processor, and so code generation can be done to execute the loop in that processor. However, elements of the vector are distributed on all processors. No matter where we run the loop, some accesses to the vector will be remote and some will be local.

Suppose the code will be run on processor 2. An aggressive optimizer can still be able to determine that vector [2] resides locally, and therefore access to this particular element can avoid the function call. Note that the code can benefit from this only if the loop is unrolled. Otherwise, a condition would still be necessary to handle vector [2]. Such condition would interfere with code motion and instruction scheduling, which is undesirable in subsequent optimizations. Furthermore, unrolling may not always be possible nor beneficial. The disclosed method utilizing a page protection technique provides a solution to access the elements of the vector so that the performance impact on the local access (vector [2]) is limited.

As previously asserted, the problem desired to be solved is that when an array distribution layout is given to the compiler and cannot be changed: How could the compiler generate code to limit the penalty of local accesses when the locality of the access cannot be determined during compile time?

Without loss of generality, the following can be asserted about array layouts. As the array elements are distributed across the processors, each processor receives a portion of the array. Within a processor, a chunk of memory is reserved for the local portion. The starting point address of this portion is kept in a directory by the processor, or in a location accessible to the processor. Using the above matrix/vector example, this local portion can be represented by: int local_vector [local _size]; local_vector is the starting point address of the local portion. For each array element, e.g. vector [i], there is also a corresponding local element offset representing the position of the element within the processor. This position is called the offset, which is an integer counting from 0, 1, 2 . . . etc.

Note, that even within the same processor, contiguous array subscripts may not translate into contiguous local element positions. The method to distribute arrays is specified by the programming language standard or the particular implementation. The relationship between i, and the actual position of vector [i] within a processor may not be linear.

The proposed method uses a layout map to help the access. This map is an array of integers (int), or other suitable integral type with dimensions the same as the corresponding shared array. This is a similar technique used by hardware architectures to map physical memory to virtual address space. Continuing with the example, the map is: int map [N]: Each processor has a local copy of this map. For the map in processor P, if vector [i] results in P, map [i] gives the offset of the local elements position; otherwise map [i] is −1. The content of the map is different for each processor.

When the array is allocated across the processors, each processor receives a local portion of the array. The local starting point address is kept in a dictionary, which keeps track of the whereabouts of all variables in the distributed memory. When allocating the local portion of the array, the proposed method also reserves the memory location immediately before this local address, and places this address under access protection. Access to this location will raise a signal or an interrupt. This is the protected page. Note, the assumption here is that the hardware provides a means for the program to place addresses or address ranges under access protection.

When the compiler generates code for the array access, it simply transforms the code into the following using the vector/matrix example previously presented. From . . . vector [i] . . . To . . . local_vector [map [i]]. . .

If the element resides in the same processor, the transformed code would access the element. If the element resides in a remote processor, the protected location would be accessed, and a signal or interrupt handler would get control. The handler would then re-route the access to the remote processor. Note, that there is still a penalty in accessing the local element, as an extra level of indirection must be traveled. However, this is an improvement over the function call overhead of the runtime library. Note also that this is used only for arrays that cannot take advantage of data locality for optimization.

There is no need to have different maps for different variables. Arrays within a data parallel program are usually distributed according to a few layout patterns (geared towards the underlying algorithm). Because the contents of the map are compile time constants, the same map can be used for all variables using the same layout. Also, the map need not be used just for arrays, it can be used for allocated storage as well. Logically, allocated storage is an array of bytes (character).

The above assumes the hardware can put an access protection on a single memory location. In practice, this is often done by protecting a page of memory (e.g., 4 k, as in the z-series), and there may be restrictions on the actual address range of such pages. As such, the above scheme is modified as follows.

If the hardware protects memory by page, but there is not restriction on the address range of such pages, the local portions of the distributed array is allocated on a page boundary, and then reserve the page immediately before the array, and protect it. Any negative offset smaller than page size can be used to indicate remote access.

If the hardware can only protect memory pages within a certain address range, a protected page is allocated within that range during program initialization. When allocating a distributed array, an address within the protected page is chosen, and use: prot_address-local_vector as the integer to represent remove access. Each shared array variable now has its own map. A map cannot be reused as previously described.

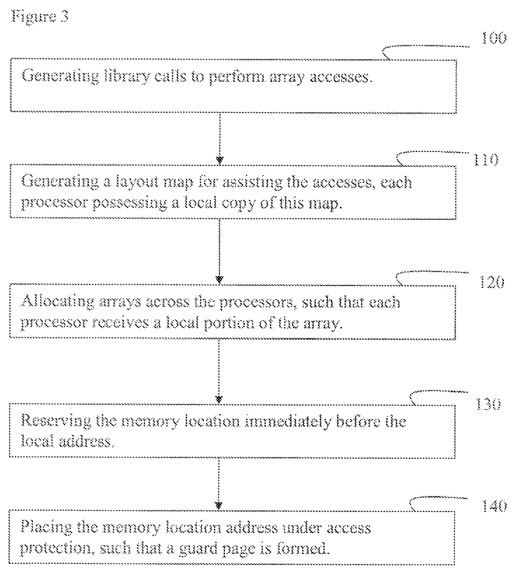

Referring to FIG. 3, a method for optimizing distributed memory access using a protected page in accordance with the disclosure is shown. At step 100, library calls are generated to perform array accesses. Then, at step 110, a layout map is generated to assist the access. Each processor has a local copy of this map.

At step 120, arrays are allocated across the processor, such that each processor receives a local portion of the array. At step 130, the memory location is reserved immediately before the local address. Then, at step 140, the memory location address is placed under access protection, such that this becomes the protected page.

When the local portion of the distributed array is allocated on a page boundary lacking a restriction on the address range of such pages, the page immediately before the array shall be reserved and protected. Furthermore, when the local portion of the distributed array is allocated on a page boundary lacking a restriction on the address range of such pages, any negative offset smaller than page size may be used to indicate remote access.

When the local portion of the distributed array is allocated on a page boundary invoking a restriction on the address range of such pages, a protected page is allocated within that range during program initialization. Furthermore, when the local portion of the distributed array is allocated on a page boundary invoking a restriction on the address range of such pages, an address is chosen within the protected page and a particular integer is used to represent remove access, such that each shared array variable has its own map.

The disclosed method is applicable to both shared memory and distributed memory architecture. The disclosed method may be used in a hybri-architecture where processors are grouped into nodes and then the nodes are connected through a network. That is, there is a hierarchy of memory organization with different access time as the memory becomes increasingly remote. The map provides a consistent way to handle code generation for memory accesses, disregarding where the memory actually resides. When the memory is remote, prot_address can carry additional information about the memory. This can be done virtually by the address itself (i.e. different address means different remote processor), or by the contents of this protected address. In the later case, a control block can be put into the protected area, providing extensive information, telling the signal handler how to route the access.

This map can be used in conjunction with other optimizations. For cases where the optimizer can determine that the memory is actually local, the map can be optimized away. Continuing with the above example, the optimizer could further transform: From . . . local_vector [map[i]] . . . To . . . local_vector [l] . . . where k linearly relates to i within the loop. The access is within a loop where i is the induction variable. Note, that the contents of the map can be computed statically during compile time accept for the prot_address-local_vector expression, which the compiler can use a special value to represent. Using the map this way, it becomes an intermediate data representation for use by the optimizer.

In conclusion, a method has been disclosed to handle accesses in a distributed memory environment when it is not possible to determine the data locality of individual accesses using static analysis. The instruction code sequence generated therefore needs to cater for all possibilities of locality. This imposes a penalty on accesses that turn out to be local. The disclosed method limits this penalty. The method can be used in conjunction with other optimizations, and can be used in shared, distributed or mixed memory mode architectures.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for optimizing distributed memory access using a protected page, comprising:
generating library calls to perform array accesses;
generating a layout map for assisting the access, each processor possessing a local copy of this map;
allocating arrays across the processors, such that each processor receives a local portion of the array;
reserving the memory location immediately before the local address; and
placing the memory location address under access protection, such that a protected page is formed.

2. The method of claim 1, wherein when the local portion of the distributed array is allocated on a page boundary lacking a restriction on the address range of such pages, the page immediately before the array shall be reserved and protected.

3. The method of claim 2, wherein when the local portion of the distributed array is allocated on a page boundary lacking a restriction on the address range of such pages, any negative offset smaller than page size may be used to indicate remote access.

4. The method of claim 3, wherein when the local portion of the distributed array is allocated on a page boundary invoking a restriction on the address range of such pages, a protected page is allocated within that range during program initialization.

5. The method of claim 4, wherein when the local portion of the distributed array is allocated on a page boundary invoking a restriction on the address range of such pages, an address is chosen within the protected page and a particular integer is used to represent remove access, such that each shared array variable has its own map.
